(19) United States
(12) Patent Application Publication
(10) Pub. No.: US 2001/0051835 A1
(43) Pub. Date: Dec. 13, 2001

(54) Method and apparatus for providing golf score tabulating services to a plurality of golfers

(76) Inventor: Dean R. Cline, Tega Cay, SC (US)

Correspondence Address: Steven B. Phillips, Moore & Van Allen, PLLC, 2200 West Main Street, Suite 800, Durham, NC, 27705, US

(21) Appl. No.: 09/874,568

(22) Filed: Jun. 5, 2001

Related U.S. Application Data
(60) Provisional application No. 60/209,523, filed on Jun. 5, 2000.

(51) Int. Cl. G06F 155/00

(52) U.S. Cl. 700/91; 700/92; 700/93

(57) ABSTRACT

Method and apparatus for providing golf score tabulating services to a plurality of golfers. Databases of golfers and/or groups are maintained, and may be accessible over a network from multiple locations. These databases contain historically based information on golfers and groups of golfers who have participated in events together, facilitating efficient set-up of new events. Events can be setup and scores tabulated to include one or more side matches between specific golfers or teams from within a group. Reports are created by tabulating hole-by-hole scores input by or for each golfer. The reports can be created for groups and/or individual golfers with detail on the results of side matches and the overall event. A report can also be generated that is customized for each golfer, showing that golfer's score as compared to every other golfer in an event group or participating in a particular side match.

### CROSS-REFERENCE TO RELATED APPLICATION

This application claims priority from co-pending provisional patent application serial No. 60/209,523, filed Jun. 5, 2000 by the inventor hereof, the entire disclosure of which is incorporated herein by reference.

### BACKGROUND

Golf is a game with a rich history spanning more than 100 years and is enjoyed by men and women of virtually all ages. Throughout the entire history of golf, forms of competition have existed between golfers, which value various elements or combinations of the golfer's score to determine a result. While many formats of competition have been developed, all require computations to be made involving the total gross score a golfer achieves on each hole that is played.

Golfers often arrange to play in groups of more than four individuals, requiring the players to separate into different playing groups with 2-6 (usually 4 if possible) individual golfers in any one playing group, or a number of golfers in a playing group allowed by the golf course and deemed appropriate by the group. A large group often sets up certain scoring methods to determine winners in a group contest, and additional matches may be arranged between individual golfers or between teams of golfers. In some large groups, some golfers or teams of golfers often play matches against other golfers or teams of golfers who are in different playing groups.

Other than pre-arranged, organized tournaments developed and sponsored at the golf club level or through various golf associations, a golfer normally arranges to play with other golfers who he or she is familiar with or with golfers who are familiar to other members of the group. Games among friends usually are a one-day event, and include a round of either nine or eighteen holes. Whether it is organized tournament or a game among friends, some sort of competition is usually included in the golf game. The competition format is agreed upon by the participants, and this competition format can vary depending on the individual golfers or teams of golfers who determine that they will compete in a “match” of some type. It is also normal for some individual golfers to have multiple “matches” going on simultaneously, each involving a comparison of different golfer's scores. If a match is arranged between golfers or teams of golfers who are not playing together in the same playing group, in order to determine results, a scorecard comparison must take place at the conclusion of play in order to determine the winner and the amount of the winning margin, if any.

One of two basic methods are often used to determine winners during any stipulated round of golf—stroke play or match play. In stroke play, the winner is the competitor who plays the stipulated round or rounds in the fewest strokes, normally calculated by adding a player's score on each hole to arrive at a total score. In a handicap match, the golfer's handicap is deducted from the total gross score to arrive at the total net score. In match play, the game is played by holes. A hole is won by the side which holes its ball in the fewer strokes. In a handicap match, the lower net score wins the hole, with stroke deductions being applied appropriately on given holes.

Some groups also enjoy playing a competition known as “skins.” This type of competition involves a scorecard comparison of the score of each golfer versus all other golfers on any hole played to determine if one golfer scored an amount of strokes, net or gross, lower than the score of every other golfer, which results in a “skin” being won by that golfer. This procedure must take place for every hole played during the designated round, and a method for accounting for the total “skins” won by any individual golfer must also be instituted.

Bogey, par and Stableford competitions are forms of stroke competition in which play is against a fixed score at each hole. The winner is the competitor who is most successful in the aggregate of holes. The reckoning in Stableford competitions is made by points awarded in relation to a fixed score, usually par, at each hole. While competitors usually maintain a running total of their Stableford score, this total is often verified by an event coordinator or another golfer, requiring a tabulation based on each golfer's scorecard.

The above list of types of competitions developed for use by golfers is not intended to be complete or all-inclusive. There are variations of the above mentioned methods of scoring an event or a match and there are other distinct methods of scoring an event or a match. But for all the methods discussed above as well as those not discussed, one requirement exists—a comparison of the scorecard of each golfer in the competition must take place at the conclusion of the played round. If the competition is based on stroke play, only one total number is reported for each competitor—the total number of strokes used in that competition. If the competition is based on match play, the competitor's scores must be compared on a hole-by-hole basis, with each hole being won, lost or halved by a side and a running tabulation of those results must be accomplished. There are a number of software programs designed to perform golf score tabulation that are marketed to the golf industry for tournament management. However, existing programs either do not offer a way to maintain on-going records of golfers and groups of golfers, or do not provide ways of accessing these records from multiple locations. They also do not provide the tabulating and reporting versatility desired by many golfers today.

### SUMMARY

The present invention fills the void described above by providing a system and method for offering a golf-score tabulating service to golfers. The invention has many possible embodiments. It some embodiments, a database of golfers and/or a database of “Master Groups” is maintained, and is accessible over a network from multiple locations. These databases contain historically based information on golfers and groups of golfers who have participated in events together, facilitating efficient set-up of new events. In some embodiments of the invention, events can be tracked and tabulated to include one or more side matches between specific golfers or teams from within the group. Furthermore, reports based on tabulating scores, which are input by or for each golfer, can be created for groups or individual golfers with detail on the results of side matches and the overall event. Also, a report can be generated that is customized for each golfer, showing that golfer's score as compared to every other golfer in an event group or participating in a particular side match.

The service is provided to a group of golfers at an event by first determining the makeup of the group of golfers for the event. In one embodiment, this can include accessing a database of golfers, including handicap indexes, and/or a database of “Master Groups.” A master group is a group of golfers who have previously played together at previous events, and will be discussed in more detail later. The master group entry in the database can include previously used teams, playing formats, scoring algorithms, etc. The event is set up using a first set of criteria including playing format, at least one scoring algorithm, and report formats. One or more side matches are optionally set up as part of the event. Each side match uses a second set of criteria, wherein there is at least one difference between the first set of criteria for the event and the second set of criteria for the side match. Event and side match formats can include teams or subgroups of golfers in competition.

At the end of the event, score entries are received through any of various means, final event results and final side match results are tabulated using the score entries, and at least one final report is produced. The final report or final reports show, in organized detail, final event results and the final side match results. The report may also include individual results as compared to a plurality of other golfer results for one or more individuals. The final report may actually take the form of multiple reports, wherein each golfer receives a customized report showing that golfer's scores as compared to all other golfers in the group, and may show results for side matches in which the golfer has participated. Optionally, intermediate results can be tabulated when some scores are entered but the event is not complete and intermediate reports produced. Also optionally, event criteria or side match criteria, such as event or side match playing format, and scoring algorithms can be changed at any time and the results re-tabulated and re-reported.

In one embodiment the method of the invention is implemented by one or more programmed computer systems accessing various databases. The systems and databases can be networked in a distributed fashion, or the computer system which executes computer program code to carry out the invention and the databases can be stored at one or more servers and the tabulated and reporting services can be provided by an application service provider (ASP) to client computer systems. The computer program code in combination with one or more computer systems forms at least some of the means to carry out the invention, however, various elements of the invention can be handled with paper, optical scanning, or manually, as will be described in further detail later.

The databases used to implement the invention in one embodiment include a golfer database of golfer identities, and handicap indexes. Each handicap index is associated with a golfer identity so that handicap index information for each golfer identity is available at a plurality of locations. The system includes a golf course database, and an event format database for enabling the set-up of events with various individual and team playing formats wherein an event can include at least one side match. The system also includes a report format database for enabling the production of score reports including individual results, event results, and side match results as well as individual results as compared to a plurality of other golfer's results. A scoring algorithm database is also used for enabling scoring calculations. A master groups database of master groups of golfer identities corresponding to golfers who have previously played events together in specified formats using specified scoring algorithms enables faster setup of events for known groups of golfers. An ads database is optionally included to enable the display of logos or advertising in conjunction with providing the golf score tabulating services.

### BRIEF DESCRIPTION OF THE DRAWINGS

FIG. 1 is a block diagram illustrating the database system used in implementing one embodiment of the present invention.

FIG. 2 is a network diagram illustrating an example operating environment of the present invention.

FIG. 3 is a flowchart illustrating a portion of the method of the present invention.

FIG. 4 is another flowchart illustrating another portion of the method of the present invention.

FIG. 5 illustrates an example blank score input form according to one embodiment of the present invention.

FIG. 6 illustrates an example partially completed score input form according to one embodiment of the present invention.

FIG. 7 illustrates an example completed score input form according to one embodiment of the present invention.

FIG. 8 is a block diagram of a programmable computer system that carries out at least some functions of the invention in at least some embodiments.

FIG. 9 is an example individual report that is produced in one embodiment of the invention.

FIG. 10 is another example individual report that is produced in one embodiment of the invention.

FIG. 11 is an example group report that is produced in one embodiment of the invention.

### DETAILED DESCRIPTION OF ONE OR MORE EMBODIMENTS

The invention relates to a method, system and process for providing golf score tabulating services to a plurality of golfers. In some embodiments, the invention uses computer systems interconnected by a network such as the Internet. The following terms related to the game of golf and to the specifics of the invention will be used in this description, and their general meanings are listed herewith:

iMatchPlay or “IMP”—a name for the system, and service of the invention, chosen for convenience in the discussion herein. The specific name is not part of the invention.

Match Play—a method of scoring a golf match between individuals or Teams, whereby the gross or Net Score on each hole for one individual or Team is compared to the gross or Net Score on that same hole for the other individual or Team. The results for the match are based on the number of holes won, lost or halved by each individual or Team rather than the total score. As used in this document, Match Play may not conform precisely to the definition used by the United States Golf Association (USGA).

Stroke Play—a method of scoring a golf match between individuals or teams, whereby the total strokes used in a stipulated round by an individual or team (total or best ball) are compared to the total strokes used by other individuals or teams.

Handicap—A number assigned to a golfer, based on his or her golf skill, which indicates the number of strokes he or she will deduct from his or her score to determine a Net Score on competition with other golfers. It can be based on the golfer's Handicap Index but can also be adjusted according to Group policies. These strokes will be applied to selected holes, determined by the Handicap rating of each hole on the golf course.

Handicap Index—A number, calculated with a formula using a golfer's most recent scores, which indicates a golfer's relative ability based on records and calculations prescribed by the United States Golf Association (USGA). This index is translated to any given golf course and adjusts the golfer's Handicap according to the difficulty rating of the golf course.

Handicap Differential Adjustment—In a designated match, utilizing the difference in Handicaps of the golfers rather than the full Handicap. This process subtracts the Handicap of the golfer with the lowest Handicap from the Handicap ratings of all golfers involved in a designated match, making the lowest Handicap golfer a “0” and reducing the Handicap of all other golfers in the match by the Handicap of the lowest Handicap golfer. (See also “Net Score”)

Hole Handicap Rating—Each hole on a golf course is ranked according to the difficulty of that hole versus the other holes on the same one-half of the course. There are normally 18 holes per golf course, with the first nine holes being assigned odd number “ratings” of 1,3,5,7,9,11,13,15, and 17 and the back nine hole being assigned even number “ratings” of 2,4,6,8,10,12,14,16, and 18. The lowest numbers designate the most difficult holes, and correspond to where Handicap strokes shall first be allotted to any player.

Gross Score—The actual amount of strokes recorded on a given hole by a golfer.

Net Score—The actual amount of strokes recorded on a given hole by a golfer reduced according to his or her assigned Handicap. If Golfer A has a Handicap of eight, Golfer A's score shall be reduced by one stroke on each of the eight holes on the golf course that are Handicap rated from one to eight. Golfer B with a Handicap of 14 shall have his or her score reduced by one stroke on each of the 14 holes on the golf course that are Handicap rated from one to fourteen. Golfer C with a 23 Handicap would have his or her score reduced by two strokes on the 5 holes Handicap rated from one to five while reducing his score by one stroke on each of the other 13 holes. If these three golfers were to institute Handicap Differential Adjustment instead of full Handicap, Golfer A would receive no stroke reduction, Golfer B would receive a Handicap of 6 (14 Handicap minus the 8 Handicap of Golfer A, the lowest Handicap of the Group), and Golfer C would receive a Handicap of 15 (23 Handicap minus the 8 Handicap of Golfer A)

Skins—A competition among a Group of golfers whereby a “skin” is earned if any one golfer shall achieve a score lower than all the other golfers on any given hole. “Big Skins” utilizes Gross Scores only while “Little Skins” utilizes Net Scores and can be based on full Handicap or Handicap Differential Adjustment.

Master Group—This is comprised of the names and records of all golfers who have previously played as part of any day's Group. A Master Group is typically a Group of golfers known to each other who play in Events together regularly, although all golfers in the Master Group need not always play in every scheduled Event. The golfers within a Master Group who play in any day's Event are known as an Event Group or “Group.” The Master Group can be added to at any time and players who will no longer participate in the Master Group can be removed. The Master Group exists to expedite the forming of a Group for any new Event and recall of Event Criteria such as individual and Teams matches previously defined, Handicap ratings of players and Handicap usage in the day's Event according to any method devised by the Master Group.

Event Group or “Group”—This refers to a group of golfers who have determined to have an Event and who are playing together at the same course on the same day at approximately the same time, normally in consecutive Playing Groups.

Playing Group—This refers to golfers who are playing together at the same time on each hole. This can be from two players to six players, depending on course regulations, and is normally four players.

Event Criteria or “Criteria”—this is all information needed to set up and tabulate an Event. It may include Playing Formats, report formats, Event Format and scoring algorithms. The Criteria for a particular Event may also be referred to as a “set of Criteria” for that Event.

Playing Format—the way a particular match of Event is organized in terms of Team organization, Scoring Format, and play style. It may also include how Playing Groups are organized.

Scoring Format—the Scoring Format is part of an Event Format, and includes items to be used as input to a scoring algorithm, such as whether the play is Skins, Match or Stroke, Best Ball, etc., as well as specification of the scoring algorithm itself.

Event Format—This is a Playing Format for an Event which includes Side Matches and their Playing Formats, if any.

Team—Two or more golfers who compete against a like number of golfers on other Teams. This competition can utilize the best ball score of any golfer on the Team or the best ball score of a given number of golfers on the Team.

Event—This refers to a given day's activity on any given golf course consisting of each golfer playing a like number of holes. A competition is devised for a Group based on the results of that day's Event. An Event takes place according to a set of Criteria.

Side Match—a competition between golfers or Teams for which scores are tabulated concurrently with the overall Event scores. A Side Match has its own set of Criteria, including Playing Format, and possibly a report format, although in most cases, the Side Match report format would be included in the Event report format.

Consecutive Tee Times—When Playing Groups within an Event Group begin play at a given hole and each Playing Group tees off consecutively.

Shotgun Start—When Playing Groups within a Group begin play at approximately the same time with each Playing Group beginning play on a different hole, and finishing the round after playing the hole which precedes the hole on which they began play.

Golf-related words and concepts included in this description will be understood by a person familiar with the game of golf and the various traditional scoring methods used by today's golfers. Additional information is contained in “The Rules of Golf” as approved by The United States Golf Association (USGA) and The Royal And Ancient Golf Club of St. Andrews, Scotland—Effective Jan. 1, 2000 and published in 1999 by the United States Golf Association, which is incorporated herein by reference.

The invention to be described herein makes use of Handicap calculations. In many cases, calculations would be performed as recommended by the USGA. The publication entitled The USGA Handicap System Manual, published by the United States Golf Association, described these recommended calculations, and is incorporated herein by reference.

The method, system and apparatus of the invention combine to be able to accomplish a scorecard comparison result sheet posting with hole-by-hole comparisons and results for a Group of golfers participating in a given day's Event. In some embodiments, the invention uses communications from a client location at a golf course to a remote server, which performs the necessary calculations and reports summary results to the client location and provides client location print controls. In any case, the invention is designed to allow the quick result posting after completed rounds while requiring little involvement or assistance from golf shop personnel or the golfers.

The invention can be implemented as a service, either using an application service provider model, either with servers and clients, or using distributed computing with relatively low-maintenance software components installed at golf courses. Providing the service allows golf shop personnel to be disassociated from any tasks required to maintain operations of the software. Some features of the invention can be provided in embodiments using stand-alone resources. In any case where the invention is embodied in a service, personnel associated with the service (IMP personnel) are responsible for software maintenance, and can provide personalized assistance to golf shop personnel and/or golfers with Event setup and scoring when needed. When a Group of golfers notifies the golf shop that they wish to have an Event scored, golf shop personnel may, if they have time available, provide initial information to set up the Event and provide scoring assistance at the completion of the Event. In some embodiment, if the golf shop personnel do not have the time or ability to help the golfers either set up or score the Event, the golfers can do so themselves via keyboard or touchsceen entry of the data at the golf shop. In some embodiments, setup information and scoring data may be entered by a portable network device or the golf shop or golfers may elect to fax or transmit via an Internet connection to the IMP system all information related to set up or scoring. In this latter case, data entry is performed by IMP personnel or an optical character recognition device. For repetitive use by a Master Group of golfers, certain golfers in that Master Group will likely become familiar with the procedures necessary to fully utilize the scorecard comparisons provided by IMP system and will therefore be able to both setup an Event and score the Event without assistance.

In one embodiment, the IMP system uses scores and the Handicap Index or assigned Handicap of each golfer along with information about the golf course and Hole Handicap Ratings to produce comparative results in the form of a report made available to each of the golfers at the conclusion of his or her round or the Event. Each golfer's report shows each results on a Match Play basis versus every other golfer in the same Event Group and also includes one report which shows results for the entire Event Group on a “Skins” basis. Numerical data shown on these reports is tabulated or calculated on a gross basis and on a handicapped basis, utilizing full net Handicaps, a percentage of full net Handicaps, a Handicap Differential Adjustment basis, or a percentage of Handicap Differential Adjustment basis according to the wishes of the Event Group. As Master Groups use the service a second and more times, the system will have stored in computer memory the previous recorded data of individual golfers and the preferred playing, Event, and report formats for scoring, Team organization and otherwise of the Master Group and offer the option of utilizing those same setup choices again with a single click of a mouse button.

In some embodiments golf shop personnel or golfers will establish a connection to servers and databases used by the invention through a networked device via the Internet. The databases are used by the IMP system for computations. The invention also includes the development and maintenance of Master Groups within a database. A Master Group is a Group of golfers who have established a certain format for play and subsequent match calculations within each Master Group and includes all individual golfers who have previously (or previously within a defined period of time) participated in an Event together. A Playing Format is a criterion or subset of Criteria used in an Event or Side Match and specifies Team organization, some aspects of scoring, and similar characteristics. When created new, the defined Master Group will be designated with certain characteristics which will determine the types of computations performed as well as the report format for the reports produced. A Playing Format, or combinations of different Playing Formats available are then selected and become associated with the Group for the day's Event and for use in future Events, determining the method of scoring to be used among the golfers and Teams of golfers. When a Master Group is recalled from a prior use, both the Playing Formats and the Report Formats will already be established, leaving only the designation of the individual golfers who will be participating in that day's Event, along with any changes in a golfer's associated Handicap. For any given day's Event, the participating golfers are selected from the Master Group, with any participating golfers who are not current members of the Master Group being immediately added, and this information is transmitted to the IMP system, which then sets up an Event for that Master Group with the appropriate golfers included. An associated data input screen or even a paper form is also prepared which will be available to golf shop personnel or the golfers to input each individual golfer's hole-by-hole scores as they become available. This information is transmitted via input through a network device located in a customer location, a golf course, being accomplished by either golf shop personnel or golfers who are familiar with the system utilizing keyboard or touchscreen based input of data or by facsimile transmission of handwritten data to the IMP service. In the case of a network device transmitting to an IMP server over the Internet, the IMP server will transmit data back to the device for screen display or printout via a printer attached to the device.

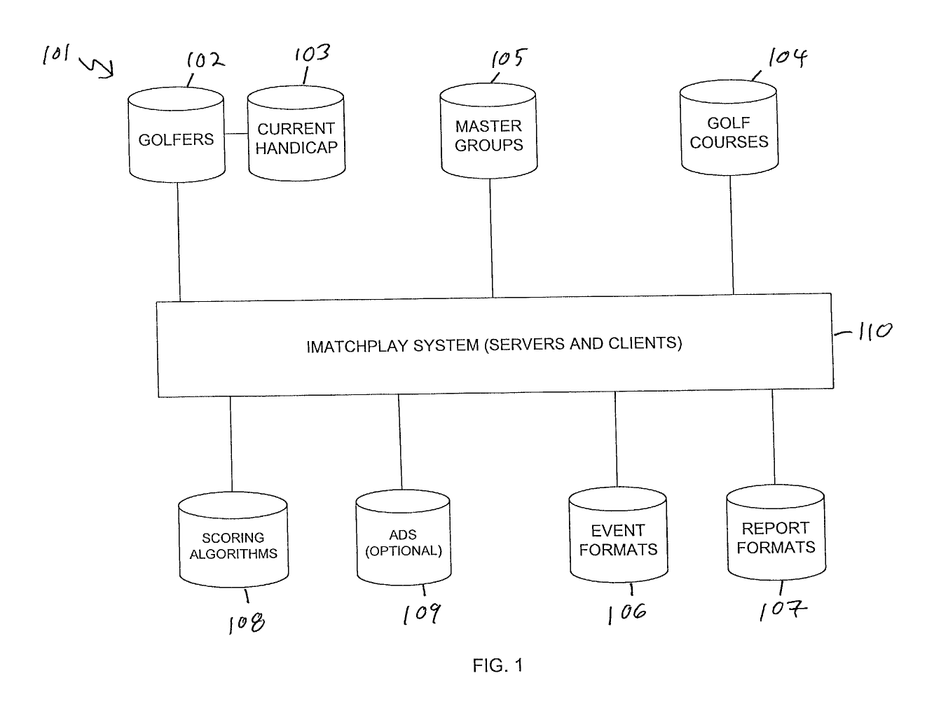

FIG. 1 illustrates the organization of databases for the IMP system described herein for the example embodiments of the invention. Golfer database 101 consists of two components. The first is the golfers identities stored as information including names, addresses, telephone numbers, e-mail addresses and certain other relevant information of all individual golfers who elect to become a “member” of the iMatchPlay system. Each record will include a user-created ID and associated password. The second component, 103, includes an associated current Handicap Index for each golfer associated with the golfer identity in the database, which changes as the golfer includes new scores. In one embodiment, each golfer is associated with a particular “home golf course”, normally the golf course where his or her iMatchPlay membership was established. The golfer database will also include the ability to create a “quick player”, with only a name and Handicap required, for inclusion in any day's Event. Normally, the “quick player” will not become part of the permanent database. The golfer database will be able to be accessed by any member golfer to receive access, with proper identification, to view their own records and the records of any Event in which that golfer was a participant.

Golf course database 104 includes the name, address, telephone numbers, pertinent personnel and golf course information for each golf course affiliated with the iMatchPlay system, and may include the names and golf course information for golf courses not yet affiliated with iMatchPlay. In one embodiment, each golf course's information includes: number of holes, names of each nine holes, names of each course when more than one 18-hole course, hole descriptions of each hole (number, yardages associated from each set of tees, par rating, Handicap rating (par & Handicap rating may be different for men vs. ladies tees)), names of all sets of tees, course rating & slope for each set of tees.

Master Groups are specified in the Master Group database, 105, and are comprised of any number of individual golfers from golfer database 101. Master Groups can be created at any time from an affiliated golf course, and any golfer can be a member of multiple Master Groups. Master Group records will be maintained to include all individual scoring records for all golfers who participated in an Event, along with the histories of each Event on an on-going basis. A “quick Group” can be established, avoiding the need to utilize a Master Group. The “quick Group” will require only a golfer name and associated Handicap in order to create an Event, and normally the scoring records will not be maintained by the iMatchPlay system and therefore not be stored in the Master Groups database.

The Event Formats database, 106, includes a variety of information allowing for different types of formation of Teams and computation of results for overall Groups, including Side Matches. This will include: 1. number of players on a Team; 2. number of balls to be counted in Team competitions; 3. type of Handicap usage to be applied to any overall Group, individual or Team competition (gross, full Handicap, differential Handicap or percentages of any of these); 4. methods of selecting Teams for overall Group competitions (manual or computer picked based on random, A-B random, A-B equalized, variety, peer and other methods); 5. different Scoring Formats including Skins (three variations), Stableford (able to establish point values), Callaway or other point based systems; 6. Inclusion of extra point values for birdies, greenies, sandies, poleys and other Group established values; 7. Other variations as may be established by any Group.

The report format database, 107, includes a variety of formats to govern the production of screen and hard-copy reports for any particular Event. These formats impart the specific look and feel to the reports, and necessarily depend on Scoring Formats and Playing Formats.

The scoring algorithms database, 108, includes appropriate algorithms for calculation of results based on selections made by the Group in relation to the Event Formats selected for any given Event. Multiple algorithms may be used for production of results for any given Event.

An optional ads database, 109, consists of: 1. advertisement logos and messages which may be created at any time for placement on hard-copy reports produced at multiple golf courses; and 2. promotional messages or logos produced by individual golf courses for placement on hard-copy reports at that golf course.

The iMatchPlay system, 110, is the software system which, in this embodiment, resides on at least an application service provider host server and possibly on local computers which are linked to the iMatchPlay system through a peer-to-peer networking system. All the databases referred to above can be located on the host server and selected databases can reside on local computers at iMatchPlay affiliate golf courses. Multiple copies of the databases can be included in the system. It should be emphasized that FIG. 1 is an illustrative example only. It is also possible to build a system using the invention on a stand-alone computing platform.

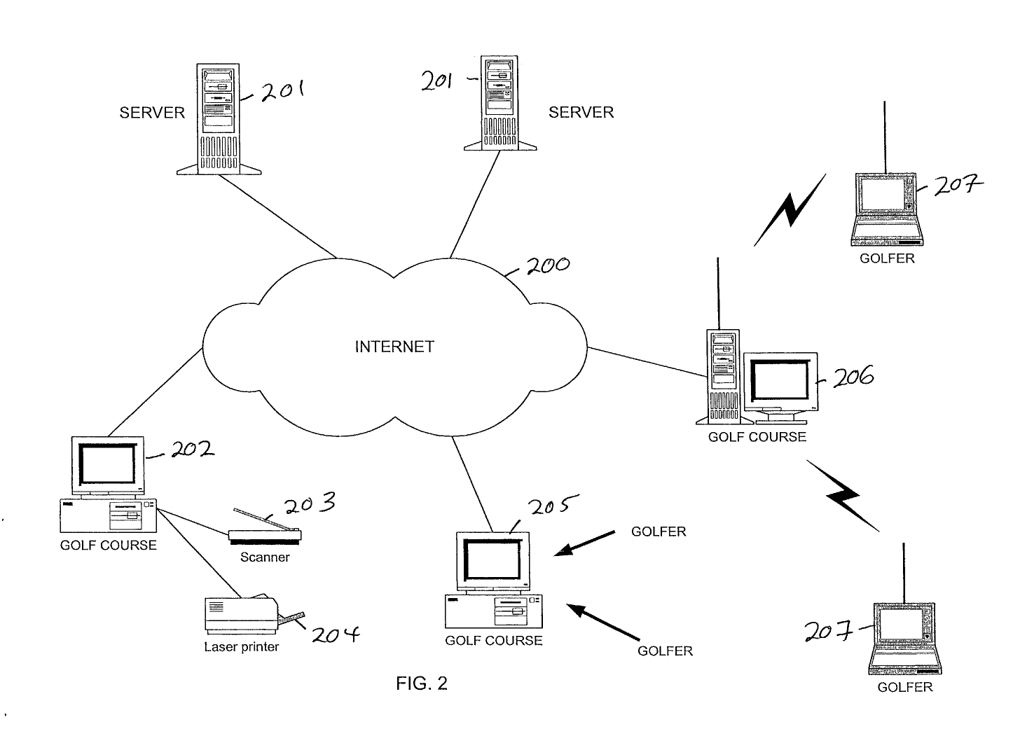

FIG. 2 illustrates an example operating environment of the invention. It illustrates some of the possible methods of communication between the iMatchPlay servers and the golf course clients and golfers located throughout the world, in this example using the Internet and peer-to-peer network communications services. Clients communicate with iMatchPlay servers to provide necessary information to maintain databases and provide scoring services for Events. The servers will transmit required data to clients as required.

In this example, the Internet, 200, is used for communications. However, leased line, local area networks, or other types of proprietary networking systems could be used. Servers 201 maintain at least some of the databases and perform at least some of the computations and tabulations required to implement the invention. Client system 202 is at a golf course. In this example, setup is performed on screen and scores are entered on paper via scanner 203. Reports are printed at printer 204. Client 205 is a system at a golf course that allows direct access by golfers. All input is performed electronically. Reports are displayed on screen, but can also be printed out (the printer is omitted for clarity). Client 206 is a golf course computer system that allows access via its screen and keyboard, and also has a printer available (again, not shown for clarity). In this case, however, golfers 207 can also access the client system for data entry and report viewing through wireless devices in their carts, over a private radio data system. It would also be possible for golfers to access the system directly from wireless devices using the public wireless Internet.

If Internet connections are used to implement the invention, documents for display and printing are sent using a form of internet protocol, such as transmission control protocol/internet protocol, or TCP/IP. Various standard protocols can be used to format data. For Internet communications generally, hypertext transmission protocol (HTTP) is important. With HTTP, a client computer specifies a uniform resource locator (URL) to access services and retrieve documents. This request is transmitted via HTTP to a computer that can process the request and return a document as a “web page”. Web pages are typically defined using hypertext markup language (HTML). The extended markup language (XML) can also be used. While HTML provides a standard set of tags that describe the contents of a web page and how it should be displayed, XML provides a standard means of describing any content through the use of user defined tags. The context and meaning of the XML tags is specified through the use of document type definitions (DTD's).

Wireless terminals that have World Wide Web connectivity typically operate using the wireless version of HTTP specified in the Wireless Application Protocol (WAP) standard published by the Wireless Application Forum, Ltd. These terminals may take the form of a traditional “cellular” telephone, but may also include a personal communications system (PCS) terminal that may combine a cellular radiotelephone with data processing, facsimile and data communications capabilities; a personal data assistant (PDA) that can include a radiotelephone, pager, Internet/intranet access, Web browser, organizer; and a conventional laptop and/or palmtop receiver or other appliance that includes a radiotelephone.

As previously mentioned, the invention can be embodied as a method and system for providing a service to golfers. This service provides a method of golf scorecard comparison among golfers playing in a Group on the same day, teeing off using a Consecutive Tee Time basis or a Shotgun Start format. In one embodiment, the system is designed to capture the individual hole-by-hole scores of each golfer in the Group, utilizing those scores and the Handicap Index or assigned Handicap of each golfer along with information about the golf course and Hole Handicap Ratings to produce the comparative results in the form of a report made available to each of the golfers at the conclusion of the Event. Externally, in an example embodiment, the process involves three basic steps, the “setup” of the Event, the “scoring” of the Event and the production of reports with tabulated results, which in some cases will be applied consecutively.

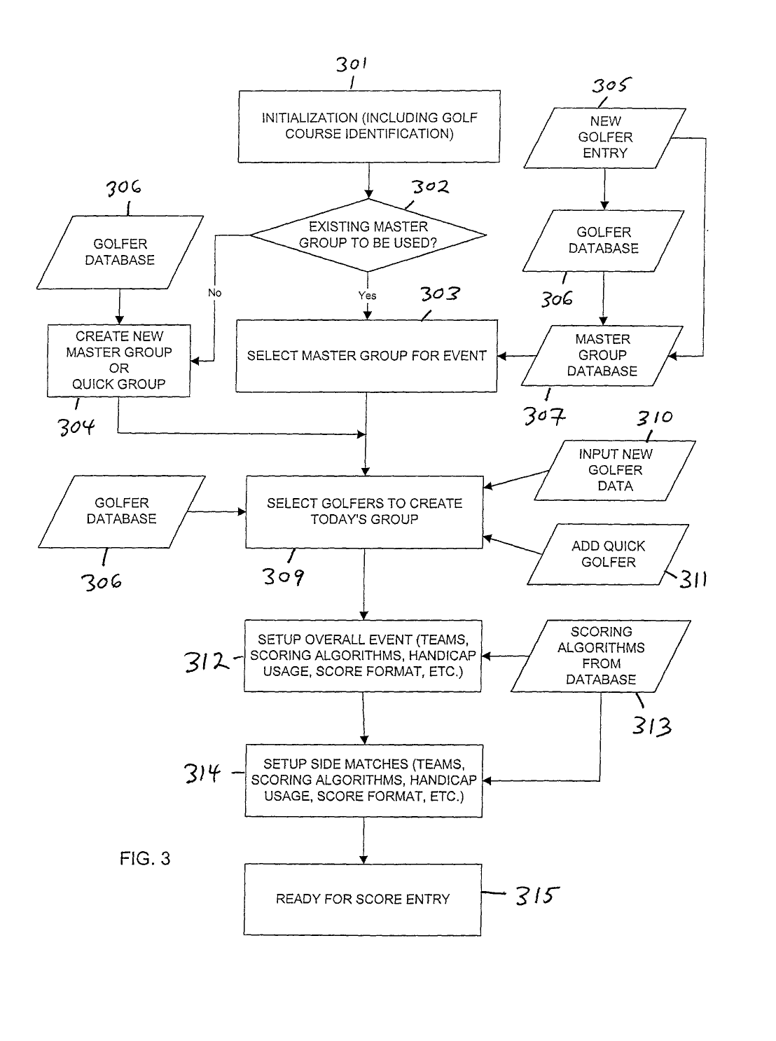

In this example, some golfers decide to utilize the service, for purposes of this disclosure, called iMatchPlay (IMP). If it is the golfers' first use of IMP, a form can be filled out by a golfer or golfers, listing a name identification of each golfer and an associated Handicap for usage in the calculations that day. This form will also allow the identification of any individual Side Matches which the participants wish to be scored using a Handicap Differential Adjustment different than the differential calculated by comparing their respective assigned Handicaps. This form also allows the identification of any Teams comprised of 2-6 golfers who wish to have a Match Play scorecard comparison versus any other Teams. The form allows selecting from a variety of types of calculations, including, but not limited to, best ball of the Team, best number of balls of the Team along with various combinations of utilizing net and/or gross ball, Stableford and Callaway. Alternatively, the golfers could create a new Master Group or quick Group electronically using step 304 as discussed below with reference to FIG. 3. If it is the Group's second or later use, the Group member's names and associated Handicaps will be available via the Master Groups database and golfer database for recall and inclusion in or deletion from the Group set-up and calculations for that day. New members can be added to the Group, and associated Handicaps can be adjusted for that day's calculations. Previous Team competition formats can be recreated for the day's use. Under some conditions, a form showing each golfer in the day's Group will be turned in to the golf shop either prior to the final Playing Group beginning play or at the end of nine holes of play, allowing golf shop personnel time to institute action to “set up” the Event for final score entry. It is possible, however, to set up and simultaneously score an Event after eighteen holes or nine holes if the Group desires.

The method of data entry to “set up” an Event can be accomplished in a variety of ways, as itemized below:

1. Golf shop personnel will access an IMP computer system, possibly via an internet connection using an Internet device located at or near the golf shop and enter the information by keyboard or touchscreen entry using an HTML, XML, or other electronic “form” supplied by the IMP system.

2. Golfers requesting the service will access the IMP system, possibly also over an internet connection using an Internet device (located at the golf shop, or a portable wireless device) and enter the information by keyboard or touchscreen entry using an HTML, XML, or other electronic “form” supplied by the IMP service.

3. A paper form is provided to the Group, to be filled out with pen or pencil either by members of the Group or golf shop personnel, intended to be transmitted to IMP and acted upon by an IMP employees or optical character recognition system to transfer the data to a server. This form can be faxed or scanned and transmitted via the Internet to IMP service, received by an IMP employee or optical character recognition system with the data being entered with security identifiers sufficient to identify the sender.

In all of the circumstances noted above, the data transmitted will be immediately recorded into the IMP system. A server may receive the information directly in digital format when transmitted from a Web device.

When rounds are completed, golf shop personnel, a golfer or a representative of the Group will cause each golfer's hole-by-hole score for the day's round to be entered in the “score sheet form” created for his Group. The method of data entry to “score” an Event will be accomplished in a variety of ways, such as those itemized above. In some cases, a combination of sources work together to provide the required information. The variations within these sources are listed herewith:

1. Golf shop personnel access the IMP system, possibly via an internet connection using a network device located at or near the golf shop and enter the information by keyboard or touchscreen entry using an HTML, XML, or other electronic “form” supplied by the IMP service. The golf shop personnel can directly enter the data from the golfer's scorecards onto the client device displaying the HTML, XML, or other electronic page, for the “score sheet form.” Alternatively, they can fill out a standard IMP form with handwritten hole-by-hole scores for each golfer and fax this form to IMP. They could also fax an actual scorecard to the IMP service, or can call the IMP service and relate the scores on a verbal basis.

2. Golfers requesting the service will access the IMP system, possibly via an Internet connection using an Internet device located at the golf shop and enter the information by keyboard or touchscreen entry using a HTML, XML, or other electronic “form” supplied by the IMP system. A golfer can also fill out a standard IMP form with handwritten hole-by-hole scores for each golfer and fax or transmit this form to the IMP service or fax or transmit an actual scorecard to the IMP service. Golfers can also call the IMP service and relate the scores on a verbal or touch-tone basis to IMP personnel or to an audiotext or voice recognition system. Golfers can also enter their scores via a wireless device located on the golf cart using a terrestrial or satellite based wireless communication system, which will transfer information to the IMP system via the Internet, a private radio data system, or a combination of the two.

All of these methods will accomplish the transfer of required information to the server.

Although it can happen in a variety of ways, including many ways for which examples have not been given, ultimately all information about the Event necessary to set up the score sheet HTML, XML, or other electronic page, and all information entered in the score sheet form itself will be delivered to the IMP system for processing. In one embodiment, an IMP server or servers will control the flow of HTML, XML, or other electronic pages to a network device running a World Wide Web application, and receive variable data from a network device. The server will receive a confirmation from the network device that the information coming from the device is complete, or believed to be complete. The server will then upload, or receive the variable information in digital format for placement in the IMP system. The server will receive the information directly in digital format when transmitted using a World Wide Web application. When a form is manually filled out and faxed to the IMP service, an IMP employee may take the information and enter the data into the system. Alternately, an optical character recognition device which reads the golf shop ID unique to transmissions from that golf shop and is able to identify the Group will interpret the data and make appropriate entry into the IMP system's “score sheet form”. However the information is received, the invention incorporates a method to allow the Event to be set up and a HTML, XML, or other electronic score sheet form be created for that Group, available at the client device and/or blank paper “score sheet forms” will be created for that Group, and for the score entry process to proceed.

The IMP system will create a Master Group when desired. The Master Group database will retain records of play of each of the Master Group members on an ongoing basis. It will allow the Master Group to be recalled and in anticipation of setting up a new Event, the day's golfers can be selected in a drag and drop operation. It will store Event, scoring, and report formats that have been previously used by the Master Group and allow any of these formats to be selected for the day's use. It will also have access to information in the golfer database, making that information available for inclusion in the setup for any Event.

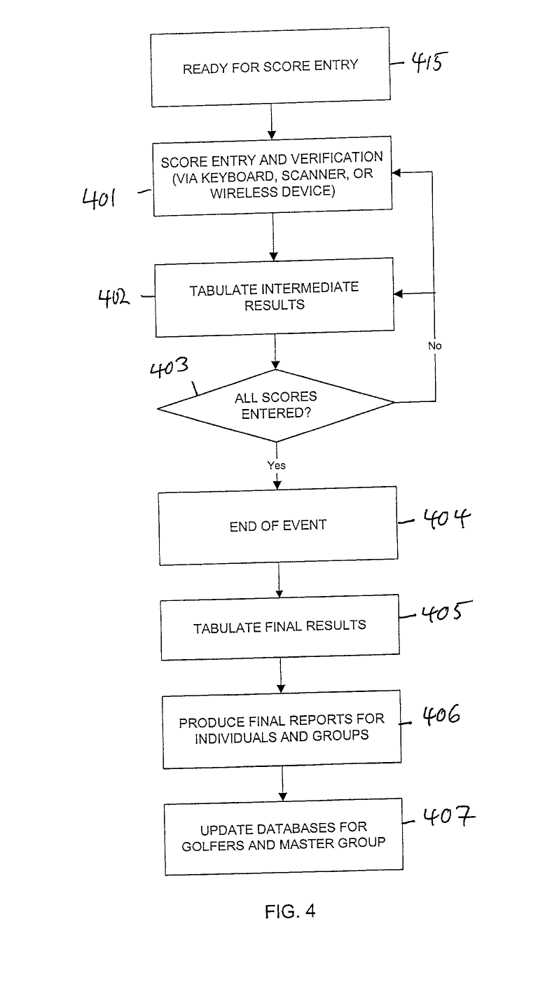

FIGS. 3 and 4 show flowcharts illustrating the method for one embodiment of the invention, which may be implemented in software to any of varying degrees. Turning to FIG. 3, which illustrates the setup process, at step 301, an initialization process takes place whereby the host server identifies the affiliate golf course computer that is attempting to log-on, and presents the appropriate Web page to the user, which will include the golf course information and make available to the user selection of any of the existing Master Groups from the Master Group database, including an existing list of Master Groups associated with that golf course or any outside Master Group. At decision point 302, processing branches to selecting a Master Group at 303, or creating a new Master Group or a “quick Group” at 304. Access is also available to the user for purposes of adding a Player or editing an existing Player through the input, 305, entitled “New Golfer Entry” which will utilize the golfer database. Input from the golfer database, at 306 and 307 is used for existing Master Groups already in the Master Group database, or creating a new Master Group. Input from the Master Group database, 307, is used in selecting an existing Master Group. (Not shown on FIG. 3 for clarity, but available to the user, is the ability to edit an existing Master Group for permanent records, deleting or adding individual golfers or editing default formats.)

A “quick Group” allows a temporary creation of a Master Group which becomes that day's Group for use in that day's Event, to be populated by golfer names and associated Handicap Indexes which are discarded by the iMatchPlay system after the Event's completion.

Once a Master Group has been selected, a process takes place at 309, usually, involving the presentation of another web page, where a list of the individual golfers who have been designated as a member of that Master Group is presented. The user will then select the members of that Master Group who are present to participate in that day's Event. This process uses input 306 from the golfers database; however, this selection can be supplemented by input 310 created by adding a new golfer, which will simultaneously add that golfer to the Master Group and to the golfer database, or by adding a golfer who will participate in that day's Event but not be added to the golfer database by creating input 311, typically done by clicking on a link labeled “Add Quick Golfer”. In any case, at this point, the Group for the Event has been determined by the preceding steps. The resulting individual golfers who are selected become the active Group for that day's Event.

The process then proceeds to step 312 where the overall Event is set up with a set of Criteria. In one embodiment, the page presented to the user lists the golfers who comprise the day's Group, along with their respective Handicaps as determined by the iMatchPlay system. (Handicap Indexes associated with each golfer can be altered by the user for use in that day's Event. This also applies to later phases of operation.) Also shown on this page are format options for that day's Event, with each option pre-selecting the default choice for that Master Group (but able to be changed for that day's Event). The user will be able to select the number of players per Team, the type of Handicap computation to be used (gross, full or differential) along with the ability to use a percentage of Handicap, the Skins or Stableford Scoring Format to be used, the tee box to be used, the course played (when appropriate) and if it is only a 9-hole Event. The user will be able to select Team pairings on a manual basis, which allows manual placement of golfers on Teams, or allow computer pairing for Teams based on a selected method of pairings, such as random, A-B random, A-B equalized, variety or peer. The user will also determine the number of balls to include in results calculation, with a default selection being listed for immediate acceptance. This process uses input 313 from the scoring algorithm database.

The process will then proceed to step 314 to set-up Side Matches with a set of Criteria for each Side Match. The page presented to the user will list the golfers who comprise the day's Group, along with their respective Handicaps as determined by the iMatchPlay system. The page presented allows the user to select the number of players per Team, and be presented with a blank “match pairing” sheet. For instance, if two-person Teams are selected, the blank pairing sheet would show:

______&______ VS.______&______ The users will then drag and drop names from the Group onto the blank pairing sheets, creating a match whose results will be calculated and reported. Golfer Handicaps will flow through to the pairing sheets, but can be altered if desired. The user will be able to select what type of Handicap adjustment to use (gross, full, differential) along with the number of balls to include in the calculation. As matches are formed and “Saved”, a list of “Matches Formed” will be created. The Side Match setup process, 314, again uses input 313 from the scoring algorithms database.

When these processes are completed, the user is ready for score entry as shown at 315. If the Event is being set-up prior to the round, the user would return to the home page. The Group's name would appear in a “Scoring” section, and when the name is selected, the user will be taken to the score entry screens. If the Event is being set-up after the round, the user will go directly to the score entry screens.

The wait state at 315 is entered alternately from the Home Page, by clicking on the Master Group name listed in the “Scoring” section, or by clicking on “Go to Scoring” buttons available in either the “Set-Up Overall Event” or the “Set-Up Side Matches” pages.

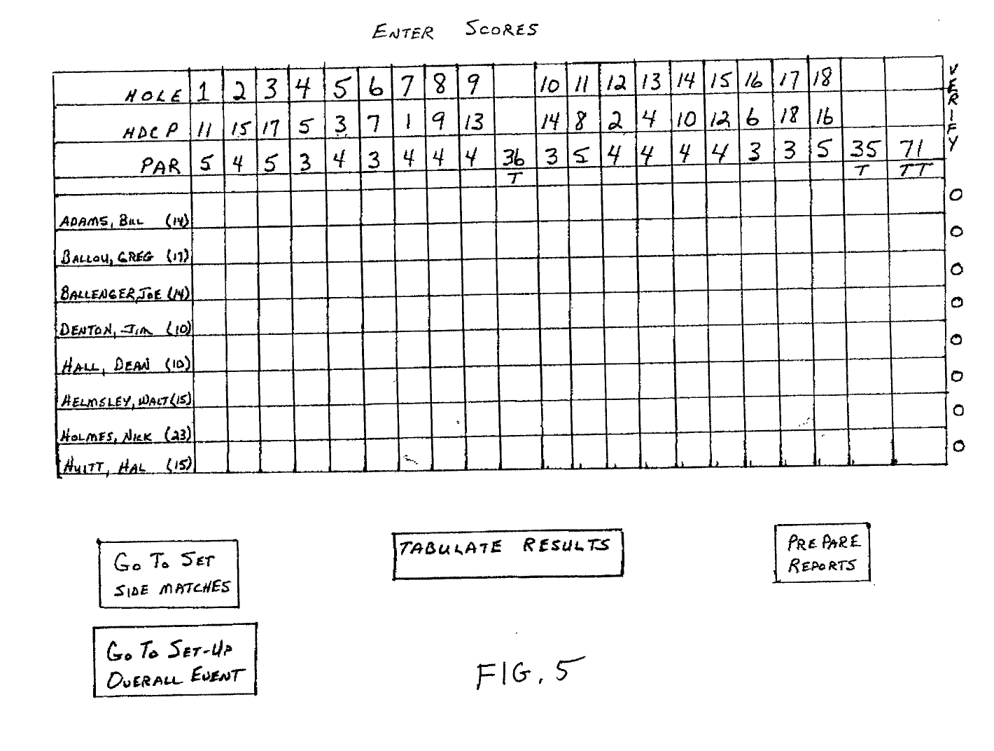

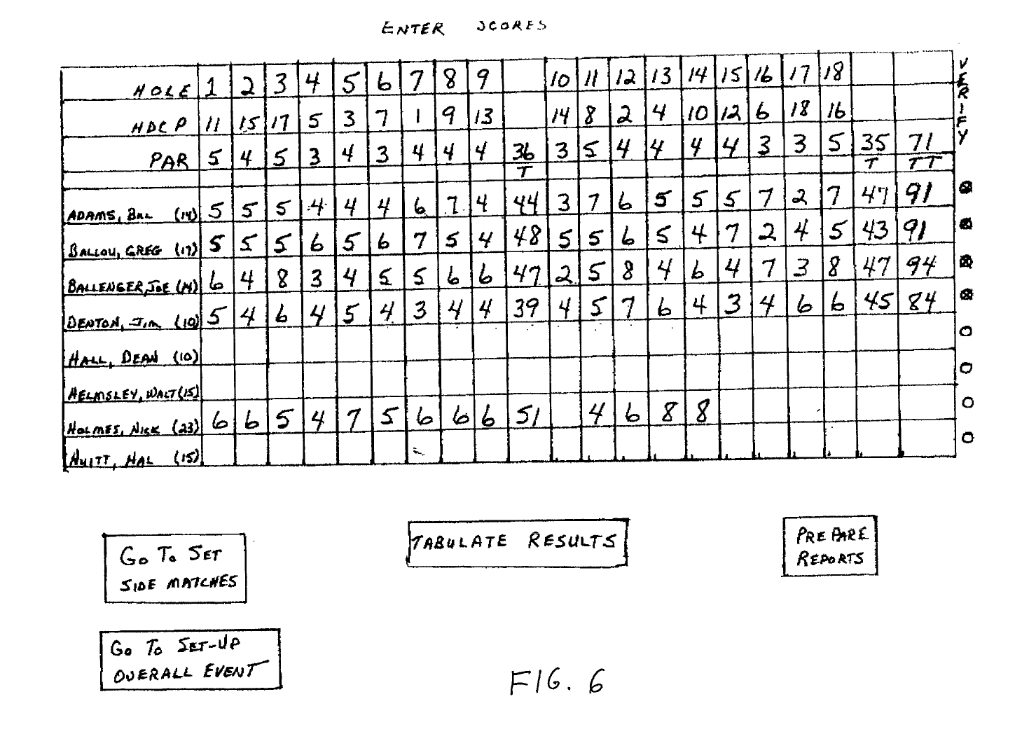

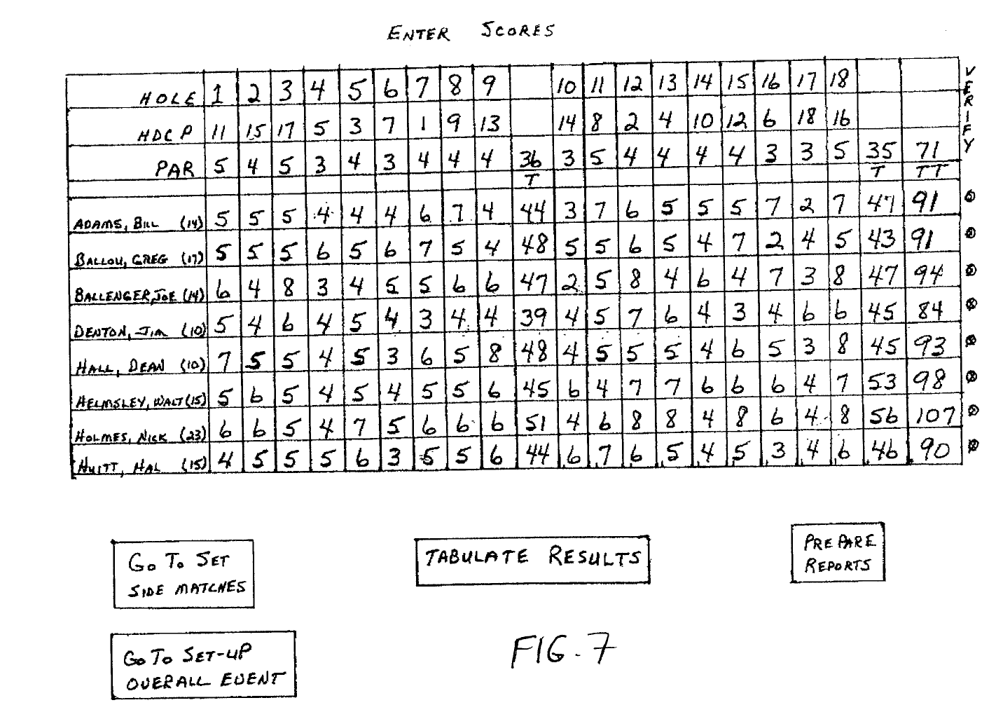

FIG. 4 illustrates the process of score entry and producing reports. The process begins with the system in a wait state at 415 as it was at the end of the process illustrated in FIG. 3. At 401, the collection of scores begins. In one embodiment, the user is presented with a score entry Web or electronic page. This page is illustrated in subsequent FIGS. The page presented is the “Scoring” page and its headline is typically labeled ENTER SCORES or something similar. Three versions of the “Scoring” page are included in subsequent FIGS. FIG. 5 represents the original page presented to the user prior to entry of any data. FIG. 6 shows partially completed data entry and FIG. 7 shows a fully completed data entry with all scores for all golfers entered and verified.

Since numerical data is part of the score sheet Figures, reference numbers, which may be a source of confusion, have been omitted. When the user for the Group is presented with the original “Scoring” page, the page resembles a scorecard, with each hole listed in order, and under each hole number is the associated Handicap rating and par rating for that hole. Below these lines are blank boxes awaiting the entry of scores on each hole for each golfer, just as a normal scorecard would have. The iMatchPlay “Scoring” Web page, however, shows a row for score entry for each golfer in the Event as opposed to a manual scorecard which has only four or five rows to accommodate the normal size of a foursome who plays together on each hole. When working on entering or adjusting scores for any player on the “Scoring” page, the color of that row is different from the row above and below, allowing the user to easily follow that row with his or her eyes.

There is a column to the left of these blank boxes in which each row is filled with the name and Handicap rating for each golfer in the Group for that day's Event. The blank boxes to the right in each row are ready to accept the hole-by-hole scores for the golfer designated in that row. This is accomplished by placing the cursor in the blank box for the first hole directly adjacent to the golfer's name for whom scores will be entered. Alternately, the user may click on the golfer's name and the cursor will be placed in the blank box for the first hole of that player. The user will enter the one-digit scores for each hole using the numeric keyboard of the computer, or if a touchscreen system is available at the affiliate golf course, using a numeric pad on the touchscreen. The cursor will advance to the next box after one digit is entered without any other keystroke. (The one exception to this method occurs if the numeral “1” (one) is entered for any hole, and then the program will display a box asking whether the user wishes to indicate a “Hole in One” score, or alternately “Enter a score of ten or more”. If the user selects “Hole in One”, a score of one will be entered in that box and the cursor will go to the next hole; if the user selects “Enter a score of ten or more”, a box will appear to accept a two-digit score for that hole, and then the cursor will go to the next hole.) As the cursor moves to the next hole's blank box, the user will again enter a single digit number and the cursor will move to the next hole awaiting a single digit entry. This process will continue until the first nine hole's scores have been entered, and then the software calculates the total and displays the total in the “T” column to the right of the ninth hole score and the cursor jumps to the tenth hole. (The user will not be able to enter data into any of the “Totals” columns.) (If the Group has pre-selected a nine-hole Event in the “Set-Up Overall Group Event” area, the cursor will return to the first hole blank box of the next listed player.) The user will continue to enter single digit numbers in the tenth and successive holes until all eighteen hole's scores have been entered. The software will then calculate the second nine hole's scores and display the total in the “T” column to the right of the eighteenth hole score and also calculate the total score for the eighteen holes and display this total in the “TT” column. When a golfer's score entry for eighteen holes has been completed, the user can press the “Enter” key or click that golfer's associated “Verify” button to verify that golfer's score, and the cursor will return to the first hole blank box of the next listed golfer with the program now being ready to accept the hole-by-hole scores of that golfer in a similar manner. (If the user desires to enter a different golfer's score, he clicks on the first hole blank box of that golfer or the golfer's name and proceeds similarly.) This process continues until all golfer's scores have been entered. It should be noted that in one embodiment a Master Group can elect to “turn off” the “Verify” requirement and make the verification requirements disappear, but the iMatchPlay system will make this option available only to experienced Master Group users.

If an error is detected by the user for any golfer's score on any hole, the user is able to click on the score entered for that hole for that golfer, or click on the golfer and use the directional cursor movement arrow on the keyboard to move to that hole, and enter in a single digit revised score for that hole. Since the system calculates the total for each nine holes and the total for the eighteen holes, if there is a discrepancy with the golfer's manual calculation of these totals on his scorecard, this alerts the user that an error may exist, although the error could be in the golfer's manual calculation of the totals. If a golfer's score has been “Verified” but a user goes back to change a score on any hole, the “Verify” button will turn blank and must be “Verified” again.

At any time during the process of entering scores, as shown in FIG. 6, the user may click on “Tabulate Intermediate Results”, initiating the process illustrated at 402 of FIG. 4, which causes the system to apply the scoring algorithms appropriately to individual matches and Side Matches for golfers who have entered and verified their eighteen hole scores versus all other golfers who have entered and verified their eighteen hole scores, along with any Side Match competitions where all participants have entered and verified their eighteen hole scores. This produces tabulated screen results for all golfers who have entered and verified their eighteen hole scores versus all other golfers who have entered and verified their eighteen hole scores, along with tabulated screen results for any Side Match competitions where all participants have entered and verified their eighteen hole scores. When this process is selected, a button will be available for the user to click which will return the user to the “Scoring” page.

Score entry is also available, when the affiliate golf course is properly equipped, by scanning in a manually completed scorecard with up to four golfer's scores on a pre-prepared scorecard which has identified each golfer with a barcode or numeric ID. If a scanning process is used, the “Scoring” page will produce the hole-by-hole results for each golfer which await verification, or error correction when necessary, for each golfer. When using this method, “turn off” of Verification will not be available.

Score entry is also available, when the affiliate golf course is properly equipped and the golfers are properly equipped, via wireless devices where hole-by-hole scores for each golfer are wirelessly transmitted to a server or the golf course affiliate computer shortly after each hole is completed or shortly after a round or an Event is completed. If a wireless score entry process is used, the “Scoring” page will produce the hole-by-hole results for each golfer which await verification, or error correction when necessary, for each golfer.

Before the end of an Event, the user can return to steps 312 or 314 of FIG. 3 in order to adjust, delete or add to the overall Group Event or Side Matches which were previously chosen. If changes or additions to the overall Event or to the “Side Matches” are desired after the end of an Event, the changes will require special administrator privileges to access this function.

Returning to FIG. 4, when it is determined at step 403 that all golfers scores have been entered and verified, as shown on “Scoring—Completed”, or simply entered if verification has been “turned off”, the score entry processing ends at 404 when a user selects “Prepare Reports” from the “Scoring” page. This will cause the system to tabulate final results at step 405, which causes the program to utilize the scoring algorithms database and apply these algorithms appropriately to all individual matches and all Side Matches for golfers along with all overall Group Event matches, including Skins competitions. The resultant tabulations from proper application of these algorithms causes the program to flow to produce the final reports at step 406 for individuals and the Group. In one embodiment, the reports are formatted and printed at a printer connected to a computer system located at the affiliate golf course. These reports will include an individual report for each golfer, showing each golfer's tabulated hole-by-hole results versus all other golfers, or versus other selected golfers, and will also show results for any Team matches which were designated when the Side Matches were set up in which that golfer was a participant. A report will also be produced for the Group showing tabulated results according to formats designated in step 312 of FIG. 3. (See examples of reports discussed below.) It should be noted that the invention does not depend on semantics of whether all the pages to be distributed to individual golfers and the Group are referred to as one “report” or whether each page of information is a “report.”

At this point, the golfer and Master Group databases are updated at step 407. This process will record the date, golf course played, tees used, Handicap used, hole-by-hole scores, total score for each golfer in the Group into the golfer database, and record similar data supplemented by overall Group results data for all golfers in the Group into the Master Group database. This information will be available for recall for individual golfers with proper log-on and password from any Internet connection to access their individual records over any period of time, along with the Event records for all golfers participating in any Event Group in which the golfer was a participant.

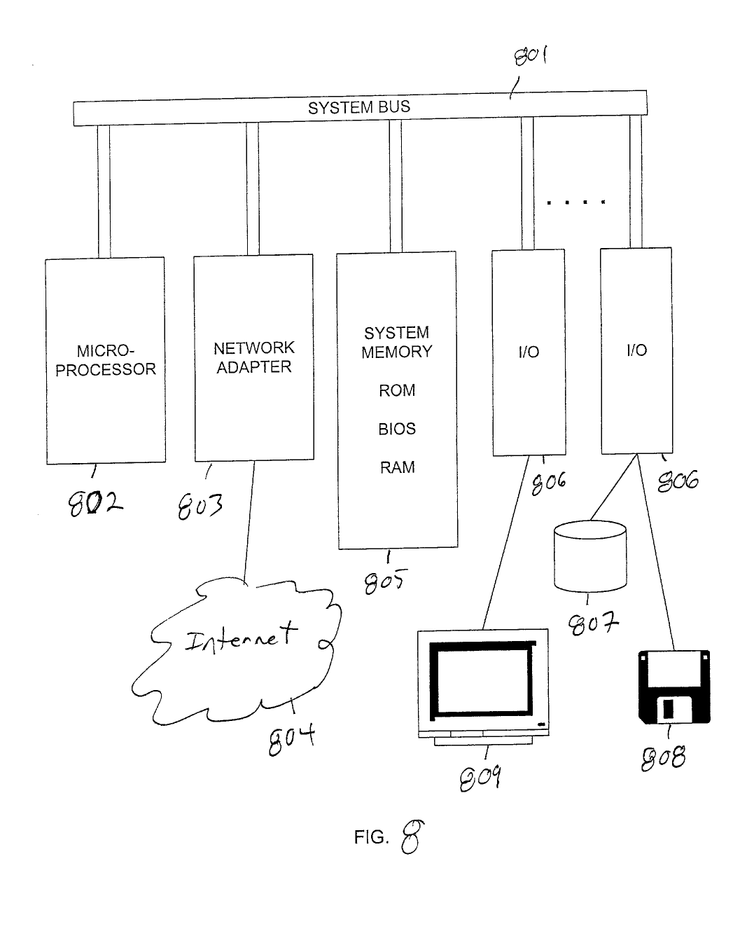

As stated throughout this disclosure, some software, one or more computer programs or computer program code can be used to implement the invention in some embodiments. This software resides on and runs on one or more computer systems, which in one embodiment, are personal computers, workstations, servers, or “dumb” terminals such as might be owned or operated by the iMatchPlay service or a golf course. FIG. 8 illustrates further detail of a computer system that is implementing part of the invention in this way. System bus 801 interconnects the major components. The system is controlled by microprocessor 802, which serves as the central processing unit (CPU) for the system. System memory 805 is typically divided into multiple types of memory or memory areas, such as read-only memory (ROM), random-access memory (RAM) and others. If the computer system is an IBM compatible personal computer, the system memory also contains a basic input/output system (BIOS). A plurality of general input/output (I/O) adapters or devices, 806, are present. Only two are shown for clarity. These connect to various devices including a fixed disk, 807, a diskette drive, 808, and a display, 809. The computer program instructions for implementing the functions of the invention are stored on the fixed disk, 807, and are partially loaded into memory 805 and executed by microprocessor 802. The system also includes another I/O device, a network adapter or modem, shown at 803, for connection to the Internet, 804, or to other types of networks. It should be noted that the system as shown in FIG. 8 is meant as an illustrative example only. Numerous types of general-purpose computer systems are available and can be used. Available systems include those that run operating systems such as Windows™ by Microsoft and various versions of UNIX.

Elements of the computer program code for the invention may be embodied in hardware and/or in software (including firmware, resident software, micro-code, etc.). Furthermore, the invention may take the form of a computer program product on a computer-usable or computer-readable storage medium having computer-usable or computer-readable program code embodied in the medium for use by or in connection with an instruction execution system. Such mediums are shown in FIG. 8 to represent the diskette drive, and the hard disk. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, aparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Various memory types can be used, for example, to store portions of code at the mobile terminal that relate to the invention. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

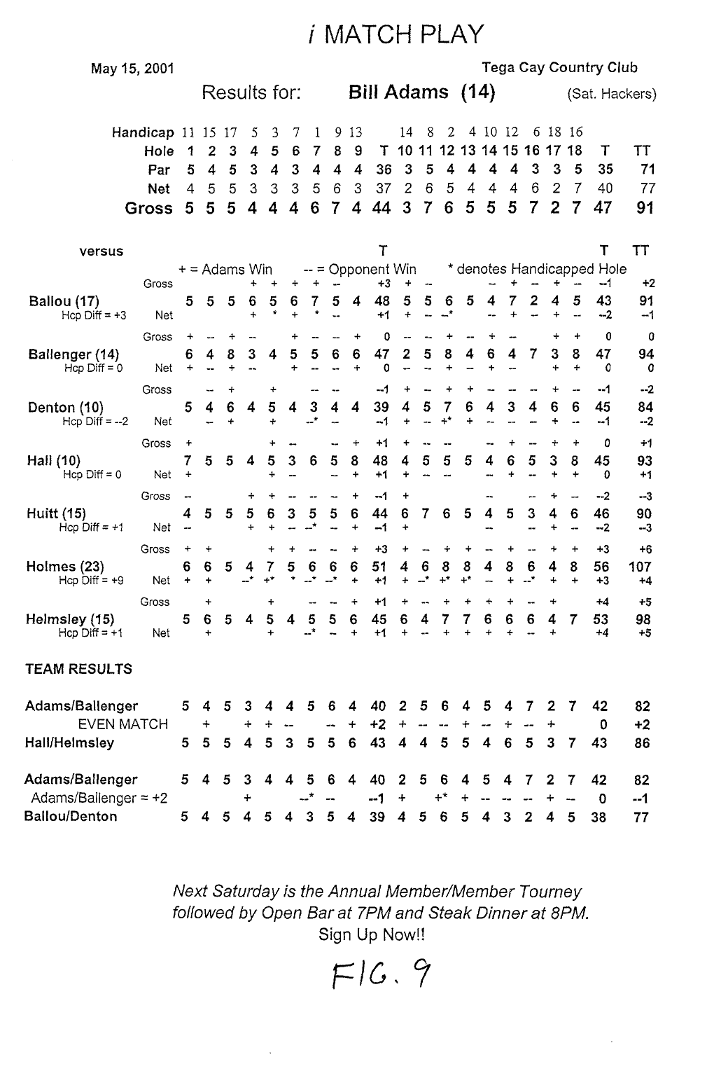

FIGS. 9-11 illustrate three examples of the final reports produced after an Event according to one embodiment of the invention. Since these figures contain numerical data, reference numbers have been omitted to avoid confusion. FIG. 9 is an individual report produced for Bill Adams, one participant in an Event played on May 15, 2001. After the iMatchPlay logo, which is shown only as an example, and which could also include advertising logos and promotional messages, the next line shows the date of the Event and denotes the golf course at which the Event was played. The next line shows “Results for:” and lists Bill Adams' name, his Handicap used for today's Event, and the name of the Group, the Saturday Hackers, used to formulate the Event.

The next five lines in the report of FIG. 9 list:

1. The course Handicap rating for that hole

2. The hole number

3. The par rating for that hole

4. The Net Score for Bill Adams on each hole. (A 14 Handicap, Adams receives a one stroke deduction on each of the 14 highest Handicap rated holes) It also shows his Handicap adjusted Net Score for each nine holes and total of 77.

5. The actual (Gross) score for Bill Adams on each hole and his total Gross Score on each nine holes and total score of 91.

The term “versus” denotes the column heading for all the opponents against whom Adams' scores are compared. Then, “+=Adams win”, “−=Opponent win”, and “* denotes Handicapped Hole” all offer a description to help Adams read the table which follows.

The next three lines of information all pertain to the opponent “Ballou”. Ballou's Handicap used for today's Event, 17, is shown by his name. Since Handicap Differential Adjustment is being used by this Group, “Hcp Diff=+3” denotes that Ballou will receive 3 strokes vs. Adams, i.e. one stroke on each of the three highest Handicap rated holes, that being hole numbers 5, 7 and 12. (If full Handicap had been used, Adams would have received a stroke on the fourteen highest Handicap rated holes and Ballou would have received a stroke on the seventeen highest Handicap rated holes, meaning Ballou would receive the stroke adjustment vs. Adams on hole numbers 2, 3 and 18.) Ballou's gross hole-by-hole scores are shown proceeding left to right across the page, as well as his total for the first nine holes, the second nine holes and his total for eighteen holes. Reading across from the word “Gross” above Ballou's hole-by-hole scores, this line shows which holes were won, lost or halved (tied) by Adams if scores are computed with no Handicap adjustment, or on a “Gross” basis. No mark denotes that the hole was halved while a +(plus sign) denotes that Adams won the hole and the − (minus sign) denotes that Adams lost the hole. Looking at each hole, the results show that Adams and Ballou had the same score on holes 1, 2 and 3, resulting in no mark, indicating halved holes. Adams scored lower than Ballou on holes 4, 5, 6 and 7, resulting in a plus sign denoting each hole won by Adams. Ballou scored lower than Adams on hole 8, resulting in a minus sign denoting a hole won by Ballou (or lost by Adams). Both players had the same score on hole 9, resulting in no mark with the hole being halved. The +3 in the first “T” column after the ninth hole denotes that Adams finished 3 holes up after the first nine holes of play. This same procedure is followed for the second nine holes with the total of Adams finishing down 1 hole on the back nine holes, and a total of 2 holes up for the entire eighteen hole match on a Gross Score basis. Reading across from the word “Net” below Ballou's hole-by-holes scores, this line show which holes were won, lost or halved, in the same manner as described above, by Adams using the Handicap Differential Adjustment, and the asterisk denotes which holes these Handicap adjustments were applied on, i.e. hole numbers 5, 7 and 12. In this case, the results on hole numbers 5, 7 and 12 changed as a result of the Handicap adjustment. On hole 5, Ballou's score is reduced by one stroke, resulting in the hole being halved instead of being won by Adams in the gross calculation. Similarly, on hole 7, Ballou's score is reduced by one stroke, resulting in the hole being halved. On hole number 12, Ballou's score is reduced by one stroke, resulting in Ballou winning the hole instead of the hole being halved in the gross calculation. The +1 in the first “T” column after the ninth hole denotes that Adams finished 1 hole up after the first nine holes of play, the −2 in the second “T” column after the second nine holes denotes that Adams finished down two holes for the second nine holes of play, and the −1 in the “TT” column indicates Adams finished down one hole for the entire eighteen holes of play under the Handicap adjusted basis.

This block of information has thus shown the opponent's name and Handicap, the type of Handicap calculation used with net amount of Handicap strokes given or received (a plus sign indicates strokes given to the opponent while a minus sign indicates strokes received from the opponent), a listing of the hole-by-hole scores of the opponent Ballou, has calculated each hole as being won, lost or halved on both a Gross Score basis and Handicap adjusted basis and noted the result, and has calculated the total results for the front nine holes, the back nine holes and the entire 18 holes.

The next three lines pertain to the opponent Ballenger, but follow the exact same procedure as listed above. With a Handicap Differential Adjustment between Adams and Ballenger of zero, this means the gross and net calculations for this match are identical and there are no asterisks shown. The tabulation procedures followed are identical to those described for Adams' match against Ballou.

The next three lines pertain to the opponent Denton, who, by agreement between Adams and Denton and selected during Side Match setup, agreed to tabulate their match based on Adams receiving a one stroke reduction on the two highest Handicap rated holes, as opposed to Adams receiving a one stroke reduction on the four highest Handicap rated holes if the normal Handicap adjustment (10−14=−4) were applied. Once again, the calculations proceed in the same manner as described above.

All results for individual matches pitting Mr. Adams against other Group golfers are tabulated in the manner described as above, with the Handicap adjustment being determined by subtracting Adams Handicap rating from each opponents Handicap rating and using the resulting difference as the basis for Handicap adjustments between those two opponents, except when Adams has made an individual agreement with any opponent to use a Handicap adjustment which differs from the result determined by comparing Handicap ratings and selected this change when Side Matches were set up.

Under “TEAM RESULTS”, the results reported are for each side Team match in which Bill Adams was a participant. Adams teamed with Ballenger to compete versus the Team of Hall and Helmsley. The participants agreed upon on even match, with no Handicap adjustments, in a best-ball match. In this case, Adams' score on each hole was compared to Ballenger's score for that hole and the lowest score is listed for the Adams/Ballenger Team. Hall's score on each hole was compared to Helmsley's score for that hole and the lowest score is listed for the Hall/Helmsley Team. The score on each hole for each Team is then compared, with the results again reported on the basis of no mark for a halved hole, a + (plus sign) for a hole won by the Adams/Ballenger Team and a − (minus sign) for a hole lost by the Adams/Ballenger Team, following the same procedure which occurred for individual matches.

In the Adams/Ballenger versus Ballou/Denton match, Adams and Ballenger received a one stoke adjustment for their score on the two highest Handicap rated holes, i.e. hole numbers 7 and 12, again denoted by an asterisk, with the scores and total results again reported in a similar manner.

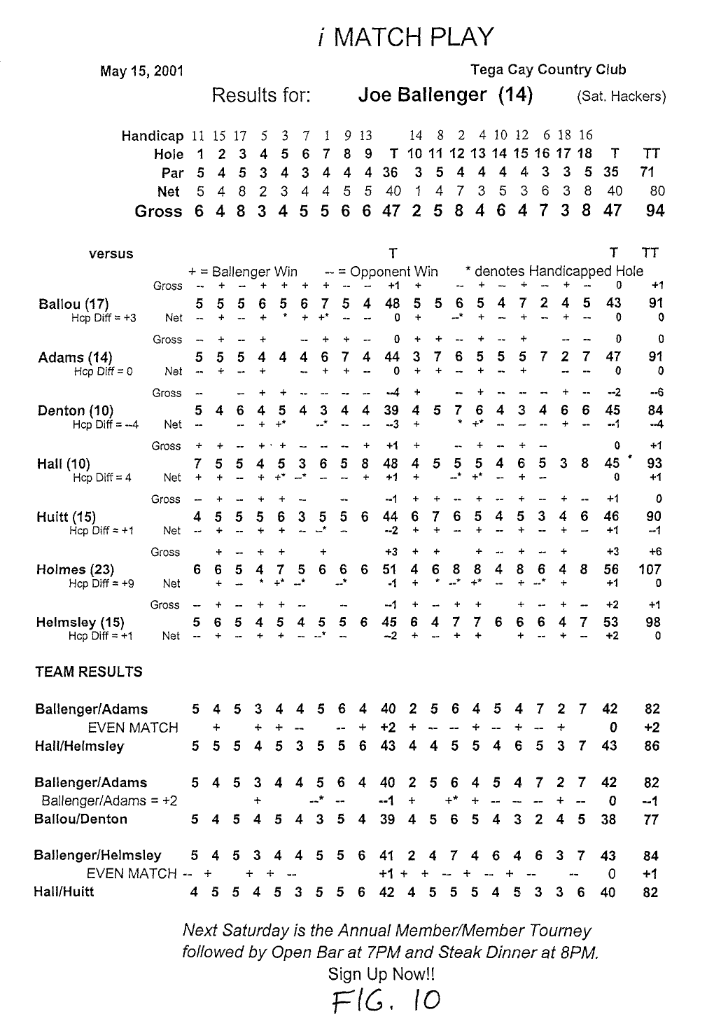

FIG. 10 shows the report produced for Joe Ballenger. It follows exactly the same format as the Adams report described previously, except all results are reported in terms applied to Ballenger. In this case, the + (plus) denotes a Ballenger win while a − (minus) denotes a Ballenger loss. Notice that the Ballenger report, when compared to the Adams report, shows a mirror opposite of holes won or lost when looking at the match comparisons of Adams' report versus Ballenger and Ballenger's report versus Adams, while holes halved are the same. This is because in an individual match, a hole won by one contestant is necessarily lost by his opponent, and these unique reports are produced from each individual player's perspective. Match results for each player versus other opponents, on the other hand, are unique and will vary considerably.

Under “TEAM RESULTS” for Ballenger, since Ballenger teamed with Adams in two Side Matches, the results report for Ballenger is exactly the same as for Adams in those matches. However, it shows that Ballenger teamed with Helmsley to compete against the Team of Hall and Huitt. It was an even match, and score comparisons followed the same procedure described previously.

Although only two participant's results reports are included for example purposes, note that each golfer in this Event can receive a unique report produced specifically for that golfer, produced in the same manner described above, including results for individual matches versus every other golfer in that day's Event, and for any Team matches in which that golfer was a participant.

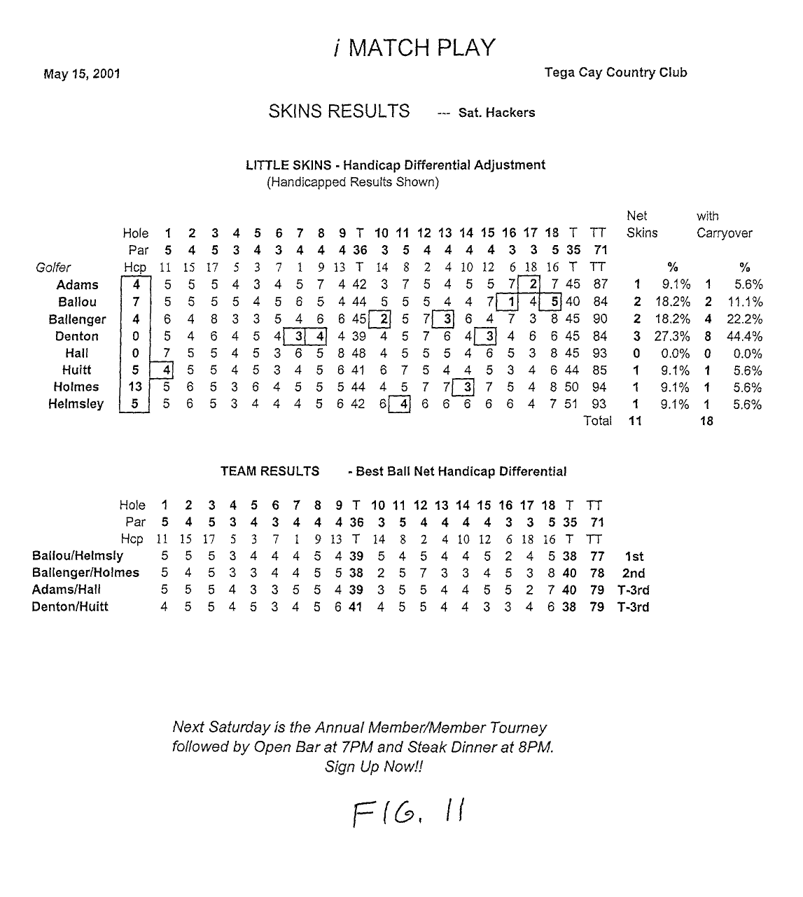

FIG. 11 illustrates an overall Group report. After the iMatchPlay or other logo, which could also include advertising logos and messages, the next line shows the date of the Event and denotes the golf course at which the Event was played. The next line shows “SKINS RESULTS” and the name of the Group, “Saturday Hackers”, used to formulate the Event. The next line denotes “Little Skins—Handicap Differential Adjustment” and denotes “Handicapped Results Shown”. (Alternate methods of computing Skins would be “Big Skins”, utilizing Gross Scores only, or “Little Skins—Full Handicap”, utilizing Handicap adjusted scores for each golfer using the full Handicap rating for each golfer.)

The first results form shows:

Line 1—Hole number

Line 2—Par rating for that hole

Line 3—Course Handicap rating for that hole

The first column shows the last name of each of the golfers participating in the Event. The adjacent column to the right shows the Handicap adjustment applied to each golfer. (Note that the lowest Handicap golfers, Denton and Hall, both Handicap rated as 10, have been reduced to zero and all other golfers have had their Handicap rating reduced by 10, in accordance with the rules for using Handicap Differential Adjustment.) The rest of this layout shows the Handicap adjusted score for each player on each hole in the same row as his name. Any score enclosed by a bold square denotes a Skin being won, i.e. that player has an adjusted score lower than all other players. The “Net Skins” column shows a total of the Skins won by each golfer, and a total of the number of Skins won by all golfers. The next column shows the percentage basis of the number of Skins won by each golfer related to the total number of Skins won by all golfers. The “with Carryover” column additionally awards a Skin for any hole in which no Skin was won to the golfer who wins a Skin on the next hole in which a Skin is won. The next column shows the percentage basis of the number of Skins won by each golfer related to the total number of Skins won by all golfers using the “with Carryover” method.

The second results form is labeled “TEAM RESULTS—Best Ball Net Handicap Differential”. This form shows:

Line 1—Hole number

Line 2—Par rating for that hole

Line 3—Course Handicap rating for that hole

The first column shows the names of the golfers assigned to Teams selected to compete in the overall Group Event. Listed across to the right of each Team is the score resulting from comparing the Handicap adjusted score on each hole by each golfer to the Handicap adjusted score of his partner on the Team and reporting the lowest score on that hole for each Team. Each nine hole score is reported, as is the eighteen hole score for each Team, and the Teams are shown in order according to the lowest Net Score, based on Stroke Play calculation.

I have described herein specific embodiments of an invention. One of ordinary skill in the networking and computing arts will quickly recognize that the invention has other applications in other environments. In fact, many embodiments and implementations are possible. The following claims are in no way intended to limit the scope of the invention to the specific embodiments described above.

I claim:

1. A method of providing golf score tabulating services for an event to a plurality of golfers, the method comprising the steps of:
determining a group of golfers for the event;
setting up the event using a first set of criteria including a playing format;
setting up at least one side match as part of the event, the side match using a second set of criteria;
receiving score entries;
tabulating final event results and final side match results using the score entries; and
producing at least one final report of the final event results and the final side match results, wherein the report further includes individual results as compared to a plurality of other golfer's results.

2. The method of claim 1 wherein at least one of the first set of criteria and second set of criteria includes a team organization, and wherein the final report further includes team results.

3. The method of claim 1 further comprising the step of tabulating intermediate event results and intermediate side match results when the step of receiving score entries is only partially accomplished.

4. The method of claim 2 further comprising the step of tabulating intermediate event results and intermediate side match results when the step of receiving score entries is only partially accomplished.

5. A method of providing golf score tabulating services for an event to a plurality of golfers, the method comprising the steps of:
determining a group of golfers for the event, based at least in part on input from a master group database and a golfer database;
setting up the event using a set of criteria including a playing format;
receiving score entries;
tabulating final results using the score entries; and
producing at least one final report of final results.

6. The method of claim 5 further comprising the step of setting up at least one side match as part of the event, and wherein the final results include both event results and side match results as well as individual results as compared to a plurality of other golfer's results.

7. The method of claim 6 wherein the final report further includes team results.

8. Apparatus for providing golf score tabulating services for an event to a plurality of golfers, the apparatus comprising:
means for determining a group of golfers for the event;
means for setting up the event using a first set of criteria including a playing format;
means for setting up at least one side match as part of the event, the side match using a second set of criteria;
means for receiving score entries;
means for tabulating event results and side match results using the score entries; and
means for producing at least one report of the event results and the side match results as well as individual results as compared a plurality of other golfer's results.

9. The apparatus of claim 8 wherein at least one of the first set of criteria and second set of criteria includes a team organization, and wherein the means for producing includes means for including team results in the final report.

10. Apparatus for providing golf score tabulating services for an event to a plurality of golfers, the apparatus comprising:
means for determining a group of golfers for the event, based at least in part on input from a master group database, and a golfer database;
means for setting up the event using a set of criteria including a playing format;
means for receiving score entries;
means for tabulating final results using the score entries; and
means for producing at least one final report of final results.

11. The apparatus of claim 10 further comprising means for setting up at least one side match as part of the event, and wherein the final results can include both event results and side match results as well as results for individual golfers as compared to a plurality of other golfer's results.

12. The apparatus of claim 11 wherein the final report can further include team results.

13. A computer program product for providing golf score tabulating services for an event to a plurality of golfers, the computer program product comprising at least one medium with a computer program embodied therein, the computer program comprising:
instructions for determining a group of golfers for the event;
instructions for setting up the event using a first set of criteria including a playing format;
instructions for setting up at least one side match as part of the event, the side match using a second set of criteria;
instructions for receiving score entries;
instructions for tabulating event results and side match results using the score entries; and
instructions for producing at least one report of the event results and the side match results as well as individual results as compared to a plurality of other golfer's results.

14. The computer program product of claim 13 wherein the instructions for determining a group of golfers access a database of golfer information, the golfer information including golfer handicap indexes.

15. The computer program product of claim 13 wherein the computer program is embodied on a plurality of media enabled to operate a plurality of computer systems interconnected by a network.

16. The computer program product of claim 14 wherein the computer program is embodied on a plurality of media enabled to operate a plurality of computer systems interconnected by a network.

17. A computer program product for providing golf score tabulating services for an event to a plurality of golfers, the computer program product comprising at least one medium with a computer program embodied therein, the computer program comprising:
instructions for determining a group of golfers for the event, based at least in part on input from a master group database, and a golfer database;
instructions for setting up the event using a set of criteria including a playing format;
instructions for receiving score entries;
instructions for tabulating final results using the score entries; and
instructions for producing at least one final report of final results.

18. The computer program product of claim 17 further comprising instructions for setting up at least one side match as part of the event, and wherein the final results can include both event results and side match results as well as individual results as compared to a plurality of other golfer'results.

19. The computer program product of claim 18 wherein the final report can further include team results.

20. The computer program product of claim 17 wherein the computer program is embodied on a plurality of media enabled to operate a plurality of computer systems interconnected by a network.

21. The computer program product of claim 18 wherein the computer program is embodied on a plurality of media enabled to operate a plurality of computer systems interconnected by a network.

22. The computer program product of claim 19 wherein the computer program is embodied on a plurality of media enabled to operate a plurality of computer systems interconnected by a network.

23. A computer readable memory system encoded with a data structure for enabling provision of golf score tabulating services for an event to a plurality of golfers, the memory system being accessible over a network, the data structure comprising:
a plurality of golfer identities; and
a plurality of handicap indexes, each handicap index associated with a golfer identity so that handicap index information for each golfer identity is available at a plurality of locations.

24. A system for enabling provision of golf score tabulating services for an event to a plurality of golfers, the system comprising a plurality of databases accessible by at least one computer system, the plurality of databases comprising:
a golfer database further comprising a plurality of golfer identities, and a plurality of handicap indexes, each handicap index associated with a golfer identity so that handicap index information for each golfer identity is available at a plurality of locations;
a golf course database;
an event format database for enabling the set-up of events wherein an event can include at least one side match;
a report format database for enabling the production of score reports including individual results, event results, and side match results as well as individual results as compared to a plurality of other golfer's results; and
a scoring algorithm database for enabling scoring calculations.

25. The system of claim 24 wherein the plurality of databases further comprises a master groups database of master groups of golfer identities corresponding to golfers who have previously played events together in specified playing formats including specified scoring formats.

26. The system of claim 24 wherein the plurality of databases further comprises an ads database to enable the display of advertising in conjunction with providing the golf score tabulating services.

27. The system of claim 25 wherein the plurality of databases further comprises an ads database to enable the display of advertising in conjunction with providing the golf score tabulating services.

28. A computer readable memory system encoded with a data structure for enabling provision of golf score tabulating services for an event to a plurality of golfers, the memory system being accessible over a network, the data structure comprising:
an index of master groups; and
a plurality of golfer identities and at least one playing format including at least one scoring format associated with each master group.
